(19) United States
(12) Patent Application Publication
(10) Pub. No.: US 2025/0139781 A1
(43) Pub. Date: May 1, 2025

(54) METHOD FOR SEMANTIC SEGMENTATION OF AN IMAGE, AND DEVICE

(71) Applicant: Robert Bosch GmbH, Stuttgart (DE)

(72) Inventors: Benjamin Pinaya Gutierrez, Brabant (BE); Steven Waelbers, Antwerpen (BE)

(21) Appl. No.: 18/691,374

(22) PCT Filed: Sep. 7, 2022
(86) PCT No.: PCT/EP2022/074791

§ 371 Date: Mar. 12, 2024

(30) Foreign Application Priority Data
Sep. 30, 2021 (DE) 10 2021 210 996.9

(51) Int. Cl. G06T 7/11; G06V 10/25; G06V 10/26; G06V 10/82; G06V 20/56

(52) U.S. Cl. CPC G06T 7/11; G06V 10/25; G06V 10/26; G06V 10/82; G06V 20/56; G06T 2207/20084

(57) ABSTRACT

A method for semantic segmentation of an image that has been captured by an environment detection arrangement of a device, in particular an automatedly moving device, using a computing system having computing power. The image is obtained and a region in the image is selected. Segments, in particular image points, of the image are each assigned one of a plurality of classes within the scope of the semantic segmentation. Based on a ratio of the selected region to the image, a higher proportion of the computing power is used for the selected region of the image than for the rest of the image. A classified resulting image is generated and in output. A device is also described.

### FIELD

The present invention relates to a method for semantic segmentation of an image that has been captured by an environment detection means of a device, in particular an automatedly moving device, to such a device and to a computing system and a computer program for carrying out the method.

### BACKGROUND INFORMATION

Mobile processing devices, such as robotic mowers, robot vacuum cleaners or wiping robots, or other domestic robots typically move in an environment to be processed, such as in a garden or in an apartment. A fundamental problem in this case is the determination of the permissible processing area, i.e., in the case of the robotic mower, for example, to where the lawn to be mowed extends, so that, on the one hand, the lawn can be mowed as completely as possible, but, on the other hand, the robot does not move beyond the lawn, for example onto a road or the like, if possible.

### SUMMARY

The present invention provides a method for semantic segmentation of an image, a device, a computing system, and a computer program for carrying out the method. Advantageous example embodiments of the present invention are disclosed herein.

The present invention preferably deals with mobile devices that move in particular automatedly, such as preferably a robot, e.g., a robotic mower. Although the present invention is to be explained below predominantly with reference to a robotic mower, other mobile devices or robots also come into consideration, in particular a domestic robot, such as a robot vacuum cleaner and/or wiping robot, floor or road cleaning devices, at least partly automated vehicles, or also drones.

It is generally desired that, for example, a robotic mower remains within the boundaries of the garden or lawn, since there can be regions that are not suitable for optimal operation, such as ponds, mud, gravel roads, flower beds, etc. For this purpose, a wire or a cable which can be captured or detected by means of a sensor in the robot can be laid in the garden or in the lawn, in particular at the edges of the lawn, or at places to where the robotic mower is to mow. In this context, reference can also be made to a lawn edge at which such a wire is laid. Although this allows the movement of the robot to be limited as desired, laying the wire or cable requires much effort.

Another possibility for a (mobile) device to recognize certain features in the environment, such as a lawn edge in the case of a robotic mower, is the use of environment detection means or of one or more sensors, such as cameras or video cameras, thermal cameras, radar sensors, lidar sensors, laser rangefinders, ultrasonic sensors, inertial sensors, and/or odometers. In particular, detection means or sensors which make a graphical representation of the environment possible, i.e., preferably cameras or video cameras, are to be considered within the scope of the present invention. However, depth information, which can be represented graphically or as (digital) images, can optionally also be obtained, for example by means of other sensors, such as lidar or ultrasonic sensors. Such an image of the environment can then be analyzed in order to recognize or identify certain things or objects in the environment, such as the mentioned lawn edge in the case of a robotic mower.

According to an example embodiment of the present invention, in particular, so-called semantic segmentation comes into consideration here. In this case, a class from a plurality of classes is assigned to each image point (pixel) in an image, i.e., the image points are labeled or classified. For this purpose, features of the image points are typically determined or extracted first, on the basis of which the class is then assigned. Such features can, for example, be the shape, color, context, pattern, light variance, and/or image context. For example, an image point could be assigned the color green, and all the surrounding image points could also be green. This would indicate lawn.

In this case, various features come into consideration as classes. In the example of the robotic mower, two classes can, for example, be used in a simple case, namely, “lawn” and “non-lawn,” i.e., for each image point of the image, it is determined whether or not this image point shows lawn. It is understood that more than two classes can also be used in order, for example, to also recognize paths, roads, buildings, vehicles or people and to optionally assign them to an image point. Also possible, in the style of the class “non-lawn,” is a class “background” to which is assigned everything that is not assigned to another class. Through all these labels, more information is added in comparison to pure object recognition in which (only) objects in an image are recognized.

In principle, the classification does not have to take place for each individual image point, but it can also take place for segments or portions of the image, which each comprise a plurality of image points. Such segments can be fixedly specified or else be formed only within the scope of the semantic segmentation, optionally also with different sizes within the image. For this purpose, one or more artificial neural networks or, in general, pattern recognition methods based on artificial intelligence are preferably used, which is discussed in more detail below.

In this way, a classified resulting image (output image), i.e., a type of map, which indicates where certain objects or, in general, features are located, can thus be generated from the image (input image). In the simple example with the two classes “lawn” and “non-lawn,” a lawn edge can be recognized or determined by a boundary between regions of the image which are assigned to either “lawn” or “non-lawn” (the associated resulting image can, for example, be purely black/white). The resulting image can then in particular be used to control the device, i.e., it can be stopped or turned before or when it reaches a lawn edge. It is also possible that, for example, a distinction is made between lawn still to be mowed and lawn already mowed as classes.

At this point, it should be mentioned that, although cameras or video cameras on or in such a mobile device preferably come into consideration for capturing such (digital) images, environment representations captured by other sensors, such as the mentioned lidar or ultrasonic sensors or also thermal cameras, or optionally obtained by further processing are also to be understood as images within the scope of the present invention, as already mentioned; semantic segmentation can then also be applied to said representations.

According to an example embodiment of the present invention, by performing this procedure in particular repeatedly or continuously for a respectively current image of the environment, i.e., in particular during movement of the (mobile) device, the mobile device can be operated or controlled on the basis of the respectively current resulting image; for example, a robotic mower can be controlled in such a way that it only moves up to a recognized lawn edge (and mows in the process) but then, for example, continues to move along the lawn edge but not beyond it.

Since semantic segmentation adds more information to an image, it can primarily be used in the field of self-driving cars in order to (better) recognize a plurality of objects and each of the classes thereof, e.g., cars, persons, traffic signs, road obstacles, etc., in an image. Other autonomous robots can also use semantic segmentation in order to obtain more information from their environment; in the case of robot arms, semantic segmentation can, for example, be used to recognize which objects are to be selected; in the case of drones, semantic segmentation can, for example, be used to recognize sky boundaries and obstacles.

However, this semantic segmentation typically requires high computing power. The use of semantic segmentation in small (mobile and in particular autonomous) devices or vehicles therefore remains a challenge due to the high computing requirements and the complex architectures of deep neural networks, which are required to make semantic segmentation quick and accurate.

Within the scope of an example embodiment of the present invention, it is therefore provided to select a region, i.e., a portion of the image, in the image and to use a higher proportion of the (available) computing power of an executing computing system in this region in the semantic segmentation of the image than for the rest of the image, i.e., the non-selected region, viz., at least based on a ratio of the selected region to the image. In other words, the available computing power (in any case, to the extent to which it is or can be used for semantic segmentation) is thus used or divided in such a way that a higher computing power is used for the selected region per image unit than for the rest. If the selected region comprises, for example, half of the image (i.e., half of the image points present in the image), more than half of the computing power, e.g., three quarters or more, is used for the selected region.

The selected region or region to be selected does not necessarily have to be a contiguous region, it can also be separate partial regions of the image.

This makes it possible to ensure a fast and nevertheless accurate determination or recognition of the features for the selected region, i.e., a region of the image (and thus of the environment) that is, for example, classified as particularly relevant with regard to certain features, while the features in the rest of the image are however nevertheless also recognized or determined. In comparison to a uniform use of the computing power for the entire image, the available computing power can thus be used more efficiently. Likewise, with the same speed and accuracy for the selected region, the necessary computing power can be reduced when features are recognized. This allows use even in smaller (mobile) devices in which less computing power is typically available.

In particular, according to an example embodiment of the present invention, artificial intelligence or deep learning (preferably artificial neural networks) is thus used in order to carry out semantic segmentation of an image and to recognize relevant segments, e.g., in the lawn region (in the case of a robotic mower). This takes place with low computing resources and high accuracy by focusing on relevant regions without losing the context of the entire image. This approach in particular uses a data set that is specific to the environment in which such a device or a robot would work, in order to train a deep learning network that concentrates on the segmentation and definition of, for example, the correct lawn or grass boundaries and other relevant objects in the lawn region, such as trees, houses, garden tools, people, etc. The region of interest in the image can thus be selected particularly simply and quickly.

This approach differs from similar approaches that are used in the field of self-driving cars or the like in connection with semantic segmentation. Semantic segmentation requires a high processing effort so that it runs both precisely and quickly. In the case of small devices or vehicles, which in particular work at ground level, this also applies, but the computing power is generally more limited there than in the case of hardware used in cars. The image for which semantic segmentation is to be performed (i.e., the input image for semantic segmentation) can (or, in any case, should) also not be tailored to the region of interest, since the context (i.e., also the rest of the image, outside the selected region) is (also) very important for a smaller and more accurate network (artificial neural network). The image is thus used as an input, a certain region is focused on (selected), but without losing the context of the entire image, while it is made possible to focus difficult computing operations to such a region in order to improve both throughput and accuracy.

The procedure according to the present invention is also (more) robust to different changes in the environment in the image, for example when the viewing angle of the camera is shifted. The approach is also robust to light changes in the environment, weather conditions, seasons, possible similar objects in the garden, etc. A major problem in artificial neural networks for semantic segmentation is that they are complex and time-consuming if they are to be accurate; if high speed is a requirement, the accuracy must however decrease if the network is small. The proposed approach now makes it possible to achieve both the accuracy by maintaining the entire image and a high speed in that a small or smaller network which mainly concentrates on relevant regions (the selected region) of the image is used.

The approach according to the present invention is more robust because more computing power is applied to the focused-on or selected region without losing context information of the entire image. The region of interest, or selected region, would usually mainly be the ground surface, but the network, for example, requires information about the weather conditions (for example, sunny or cloudy) in order to adapt to the current ground surface. When it is sunny, for example, the grass or the lawn usually appears to be greener to the camera than when it is cloudy. If the network were distorted toward or with respect to the color, errors would occur in one of these two scenarios. In contrast, it can be better generalized (adapted) with context information.

The approach according to the present invention is in particular also unique in comparison to other deep learning solutions in that it is oriented toward the designed environment (e.g., garden and outdoor area) and toward devices or robots that work close (or closer than, for example, self-driving cars) to the ground.

The segmented image can, for example, be used in order to delineate the lawn edge or grass boundary of lawn areas. As has been found, this delineation is accurate enough in order to be able to replace conventional limiting cables, for example. A robot that operates closer to the ground must concentrate more on the objects and boundaries in its vicinity but must not lose sight of objects farther away. This procedure can also be used to, for example, teach the device or robot the boundary of the garden while the robot newly learns or encodes its boundaries, since it helps to recognize the presence of grass, soil, street, water, dirt, flower beds, weeds, etc., which are present in the garden or in the ground plane. The use of segmentation can also help in localization in that it provides the context of the image objects and helps to understand the environment thereof.

The functional principle of most methods for semantic segmentation is to analyze the entire image and to carry out the same set of computing operations for each region, which has the result that the same or a uniformly distributed computing power is also used. This is useful in other regions due to the unpredictability of the appearance of the objects in the image (e.g., in the case of self-driving cars). However, in particular in the case of small autonomous robots, the area of use and the perspective are well defined due to the robot dimensions, camera configuration, placement, and orientation. For example, by analyzing a plurality of internal data sets (e.g., through training carried out in advance), the region in which, for example, grass usually appears in the image can be averaged and, after projection onto the image, a region of interest can be ascertained, i.e., selected. Nevertheless, the procedure according to the present invention is also suitable for other devices in which features in images of the environment are to be recognized.

According to an example embodiment of the present invention, the region in the image for which the higher computing power is used is in particular selected on the basis of a position of the environment detection means (e.g., the camera) in the device, in particular with respect to a plane or surface (e.g., the ground) on which the device moves. Advantageously, the region in the image is also selected on the basis of a current position of the device within the environment, expediently with regard to an operating region of the device in the environment. The procedure for selecting or obtaining the region of interest is in particular carried out mathematically, i.e., for example, by analyzing the camera orientation with respect to the ground plane and selecting a boundary of the operating region of the robot; for example, the robot should be able to recognize all of its objects within three meters.

Within the scope of the present invention, an artificial neural network (or deep learning network) preferably receives an image (or also an image pair) after the image has been preprocessed by a localization engine, and carries out a dimensional reduction via, for example, small or few convolutional layers of an artificial neural network, typically in addition to a user-defined layout of batch normalization, pooling mechanisms, and activation functions. Features are then extracted. This can initially take place for the entire image.

Image pairs can be captured in order to generate depth information or recognize them in the network. This increases the information content. For example, recognizing walls is a challenge since they usually have one color and a lower texture; if depth information is present, they can be recognized more easily and segmented correctly.

A localization engine is in particular used to rectify the recorded image, i.e., in particular the distortion of the objective, and to optionally also carry out a color correction.

The dimensional reduction helps, for example, to reduce the number of inputs or input values (for the neural network) in order to facilitate processing by carrying out convolutions and focusing on relevant features. An image with, for example, only 720×480 pixels and three color bits already results in 1,036,800 input values, which is generally too much for processing. Pooling achieves down-sampling by selecting certain values, which are transferred to the following layers (e.g., the so-called max pooling would select and transfer the maximum value in a matrix of 2×2, whereby a size of 2×2 pixels is reduced to 1×1).

Activation functions are, for example, like logic gates in an integrated circuit. They decide which neurons are activated in each stage of the neural network and make a decision about the final output (for the portion of grass or lawn, neurons that focus on the specific grass patterns, textures, and colors would, for example, be activated). Batch normalization mitigates the problem of the so-called internal covariate shift and smooths the target function by standardizing the inputs in each batch.

In addition, a region of interest of the image is also selected or extracted in order to apply a further set of larger convolutions or a higher number of convolutions, optionally in addition to other operations, to the selected region of the image. This makes it possible for the artificial neural network to take into account the entire image and to focus heavier convolution kernels (i.e., kernels with a higher weight) on the region of interest, or selected region.

In other words, more computing operations are thus carried out in the selected region than in the rest of the image. This can, for example, take place by first performing a feature recognition for the entire image and then, additionally, further computing operations for the selected region, as a result of which the features there are recognized more accurately or better. For example, additional neural networks can then be used in the selected region. However, it is also possible that the feature recognition takes place separately for the selected region and the rest of the image (from the beginning). In this case, different artificial neural networks, which differ, for example, in the depth and/or in the number of layers, can then, for example, be used for the selected region and the rest of the image.

Calculations (convolution, pooling, batch normalization, activations) for the entire image are simpler in comparison to those carried out for the (selected) region of interest. Since the entire image is evaluated, no context information is lost, but more calculations are carried out in the region of interest so that it is possible to concentrate on the segmentation. In the upper region of the image is usually, for example, the (less interesting) sky, which does not contain any relevant classes that are helpful when the lawn edge is to be recognized; however, it is relevant to recognize whether it is cloudy, sunny, etc. Grass and the closer objects (close to the robot) are usually, for example, present in the lower region of the image; therefore, more calculations are in particular carried out there in order to obtain more accurate segmentations.

Since the result of the feature recognition is scaled down (due to the aforementioned dimensional reduction), it is also possible, for example, to store a few values (on the basis of which the features are determined or extracted) beforehand so that scaling up the result becomes more accurate. When scaling down, values can be stored and then be used again when scaling up, in order to obtain a more accurate output. If, for example, a 10×10 matrix is reduced to a 2×2 matrix and then again increased to a 10×10 matrix at the end, the output (i.e., the resulting image) would be blurred and inaccurate. If, however, intermediate values are stored in a 5×5 matrix, for example, these stored intermediate values can be used when scaling up. The extracted features can then be selected, linked and provided with threshold values for the specific classes (i.e., grass, road, dirt, people, house, etc.) and then be scaled up into a feature map, i.e., the probabilities of each of these classes can be stored in the image. This then represents the resulting image. For a more detailed explanation, reference is also made at this point to the statements regarding the figures, in particular FIG. 2.

A computing system according to the present invention, e.g., a computing unit, such as a control device of a robot, is configured, in particular programmatically, to carry out a method according to the present invention.

The present invention also relates to a device, in particular a mobile device, with such a computing system (e.g., as a control device) and an environment detection means, such as a camera, for capturing an image of the environment. The device is preferably designed as a robot, in particular as a robotic mower, as a domestic robot, e.g., a robotic vacuum cleaner and/or wiping robot, as a floor or road cleaning device, as an at least partly automated vehicle, or as a drone.

Furthermore, the implementation of a method according to the present invention in the form of a computer program or computer program product having program code for carrying out all the method steps is advantageous because it is particularly low-cost, in particular if an executing control unit is also used for further tasks and is therefore present anyway. Finally, a machine-readable storage medium is provided with a computer program as described above stored thereon. Suitable storage media or data carriers for providing the computer program are, in particular, magnetic, optical, and electric storage media, such as hard disks, flash memory, EEPROMs, DVDs, and others. It is also possible to download a program via computer networks (Internet, Intranet, etc.). Such a download can be wired or wireless (e.g. via a WLAN network or a 3G, 4G, 5G or 6G connection, etc.).

Further advantages and example embodiments of the present invention can be found in the description and the figures.

The present invention is illustrated schematically in the figures on the basis of an example embodiment and is described below with reference to the figures.

### BRIEF DESCRIPTION OF THE DRAWINGS

FIG. 1 schematically shows a device according to the present invention in a preferred embodiment in an environment.

FIG. 2 shows an image that has been captured by an environment detection means (arrangement) of a device, and a resulting image generated therefrom by means of semantic segmentation, according to an example embodiment of the present invention.

FIG. 3 schematically shows a sequence of a method according to the present invention in a preferred embodiment.

### DETAILED DESCRIPTION OF EXAMPLE EMBODIMENTS

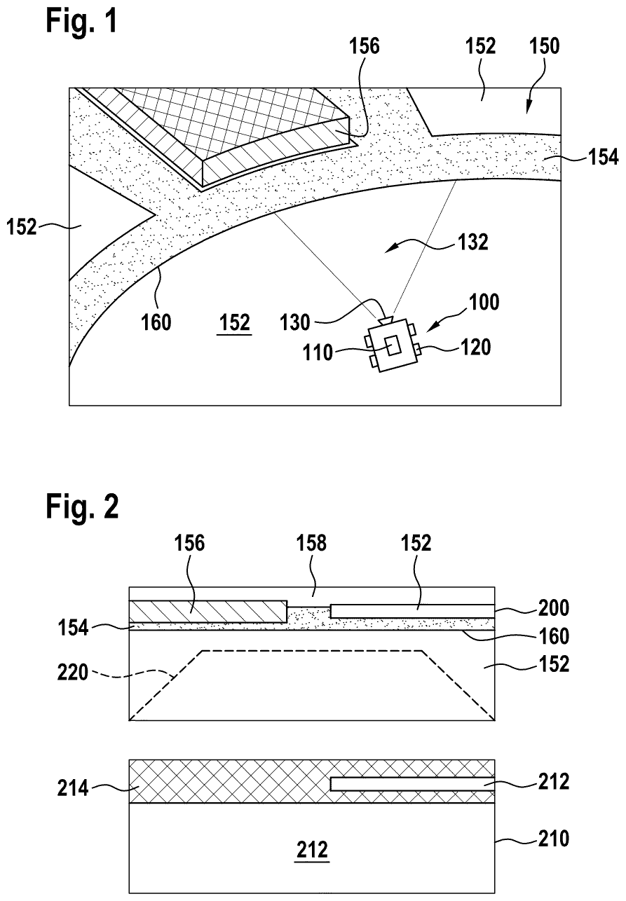

FIG. 1 schematically shows a device 100 according to the present invention in a preferred embodiment in an environment 150, e.g., a plot of land. The device 100 can in particular be a robotic mower with wheels 120, a computing system 110 designed as a control device, and a camera 130 with a field of view 132. For better illustration, the field of view 132 is selected to be relatively small here; in practice, the field of view can, however, be at least 180° or at least 270°, for example.

Here, the environment or the plot of land 150 comprises, by way of example, various regions, namely, lawn 152 (a large lawn area at the bottom in the image and two smaller lawn areas on the left and at the top on the right in the image); a path 154, which extends from the left to the right in the image and has two branches upward; and a wall or garden wall 156 between these two branches of the path.

The robotic mower 100 is to move independently across the plot of land and to mow the lawn 152 in the process. For this purpose, it is however, for example, important that the robotic mower 100 recognizes a boundary of the lawn, here a lawn edge 160 between the large piece of lawn 152 at the bottom and the path 154. This is necessary so that the robotic mower 100 does not move beyond this lawn edge 160, for example, or, if so, does not continue to mow in any case. It is possible that the robotic mower is allowed or should move across the path 154 to the other lawn areas but does not mow while it is on the path 154. Furthermore, recognizing the lawn edge 160 is, for example, important in order to be able to move along it in order to mow there.

In the upper representation, FIG. 2 shows an image 200 that has been captured by an environment detection means, such as the camera 130 of the robotic mower 100 of FIG. 1. The various pieces of lawn 152, the path 154 and the wall 156 can be seen therein as can a sky 158. It can already be seen here that a large portion of the image 200 consists of lawn, which results in particular due to the position of the robotic mower 100, or the camera 130 thereof, close to the ground.

The lower representation shows an image 210 which is a resulting image generated from the image 200 by means of semantic segmentation. In this case, features are extracted from the image 200, for example for each image point (pixel), and are then used, for example, to assign one of a plurality of classes to each image point. By way of example, only the classes “lawn” 212 and “no lawn” 214 are to be used, which can be quite sufficient for a robotic mower. In the resulting image, these two classes are white (212) and shaded (214); in practice, this can be in black/white or, in the case of more than two classes, in different colors; various other features that can be processed digitally can also be used.

As mentioned, in semantic segmentation, the entire image 200 can be processed uniformly, in particular during the extraction of the features. Within the scope of the present invention, however, a region of the image 200 is to be selected in which, based on a ratio of the selected region to the (entire) image 200, a higher proportion of computing power of the executing computing system, e.g., of the control unit 110 of FIG. 1, is used than for a rest of the image 200. By way of example, such a selected region is denoted by 220; this is a lower, central region of the image 200.

The selection of this region 220 can in particular take place on the basis of a current position of the robotic mower 100 within the environment 150, and due to the fact that the camera thereof is located relatively close to the ground. For example, it can be taken into account that a large portion of the image in the lower region will be lawn, which is due to the particular viewing direction of the camera of a robotic mower. Due to the robot configuration and the camera placement and orientation, it can be determined at least approximately where the horizon line (below the sky 158 in FIG. 2) extends in the image, assuming a flat ground; the lower central part of the image will therefore generally contain the more relevant features (lawn or lawn edge).

It can thus be assumed that the lawn edge 160 is located in the selected region 220, in any case if the robot is close enough to the lawn edge 160, so that a semantic segmentation with increased computing power in comparison to the rest is sensible there; the lawn edge 160 can thus be accurately determined despite low computing power overall.

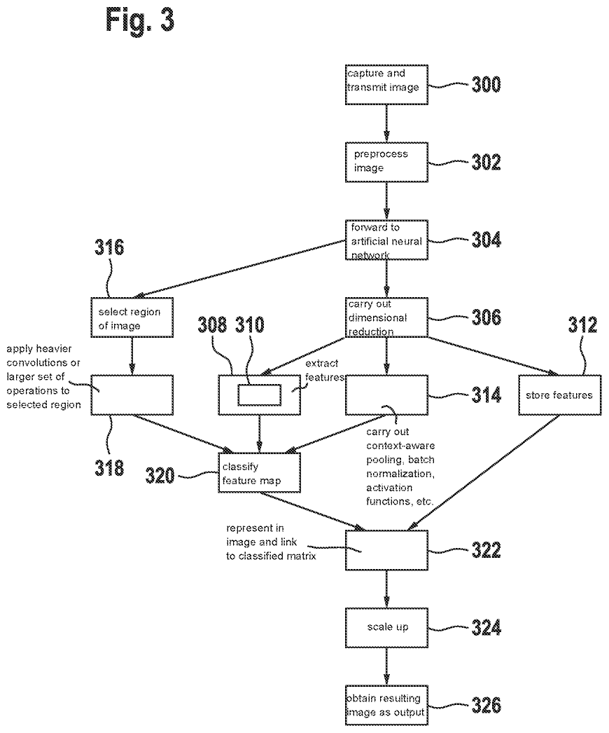

FIG. 3 schematically shows a sequence of a method according to the present invention in a preferred embodiment, namely, in the form of a flow chart. An exemplary order of steps that can be carried out is shown here.

In a step 300, an image, such as the image 200 of FIG. 2, is captured and transmitted to the computing system. There, the image, as an input image, can optionally be preprocessed by means of an image processing system in a step 302 in order to correct lens distortions, light conditions, perspective, etc. The (optionally preprocessed) image is then forwarded to an artificial neural network 304 for processing.

In a step 306, a dimensional reduction is carried out. Since the calculation cannot (or should not) be carried out for each pixel of the image due to the size (amount of data), the image dimension is reduced via convolution, pooling, batch normalization and activation functions, as explained above.

Then, in a step 308, features 310 of the image are, for example, extracted on the basis of a plurality of factors, such as shape, color, context, pattern, light variance, image context. By definition, a feature is, for example, an individually measurable property or a characteristic of a phenomenon. For the context of a neural network, this would, for example, mean training specific neurons to concentrate on certain properties of the image; some neurons could concentrate on color, patterns, textures, etc. The extraction of features is in particular to be understood to mean that certain regions in an image activate certain neurons and the network forwards the value thereof for analysis, threshold value determination, and finally segmentation into the specific class.

A portion of these features is stored in a step 312 in order to later ensure simple and quick upscaling, which means that they contribute to scaling the result to the size of the original input image without losing the resolution. The network also learns the stored values; this is more efficient than an interpolation of values or an interpolation of the nearest neighbor since context information is added. For example, in order to scale up a square, only four points usually have to be used; in order to scale up a circle, significantly more points would be necessary, at least in the image processing.

Furthermore, in a step 314, context-aware pooling, batch normalization, activation functions, and others can be carried out. “Context-aware” is to be understood to mean that the network extracts contextual information, for example: “This image region looks like a door, a window, and a wall. The entire region is thus most likely a house.” If something is then found in this “house” that appears to most likely be sky, the information can be discarded since it does not fit into the context. This facilitates or has the result that no “grass” is recognized in the middle of the sky, since this is impossible with context awareness.

In a step 316, a region of the image (e.g., the region 220 of FIG. 2) is selected; this region can be determined or calculated in two ways, namely, for example, by analyzing an existing data set of images and averaging the percentage of the (current) image that contains grass. It is also, for example, possible to use a method that depends on the physical properties of the robotic mower, the placement of the camera and the orientation thereof with respect to the ground surface.

The heavier convolutions or a larger set of operations by means of the neural network then concentrate on the selected region in a step 318, while (only) a smaller set of operations is applied to the rest of the image.

In a step 320, the resulting feature map is then classified into its corresponding classes, but, for example, not limited to: “lawn” and “no lawn,” as shown in FIG. 2. The results of the calculation for the rest of the image and of the focused calculation in the selected region are represented in the image and linked to a resulting classified matrix 322. The classified matrix (i.e., an intermediate result) is then scaled up in a decoding phase with the residua (the stored features or values) of the encoding phase, step 324, in order to obtain as output, in step 326, a resulting image that resembles the input image in size.

The resulting image can then, for example, be mapped and, if required, post-processed (for example, indexing of the classes, separation of the output classes, threshold values) and forwarded to possible applications.

Different arrangements or a different order of this approach or of the steps can be selected; as has been found, carrying out the selection of the region of interest after the dimensional reduction is, for example, possible with low effects on the accuracy and can even achieve better inference times. Even the context-aware feature selection can take place both in the entire image and (only) in the selected region, for example depending on the application and how strongly the focus on the selected region is to be.

1-14. (canceled)

15. A method for semantic segmentation of an image that has been captured by an environment detection arragement of an automatedly moving device, using a computing system having computing power, the method comprising the following steps:
obtaining the image and selecting a region in the image;
assigning each segment of a plurality of segments including image points of the image, one of a plurality of classes within a scope of the semantic segmentation;
based on a ratio of the selected region to the image, using a higher proportion of the computing power for the selected region of the image than for the rest of the image; and
generating and outputting a classified resulting image.

16. The method according to claim 15, wherein the segments of the image are each assigned one of a plurality of classes by features being determined for each of the segments of the image, and wherein each class is assigned based on the features.

17. The method according to claim 16, wherein: (i) determining the features for the selected region and the features for the rest of the image is performed using artificial intelligence-based pattern recognition methods including artificial neural networks, which are different from one another and/or have a different depth and/or have a different number of layers, and/or (ii) determining the features for the selected region is performed using an additional, artificial intelligence-based pattern recognition method including an artificial neural network, with respect to the rest of the image.

18. The method according to claim 17, wherein, before determining the features, only the rest of the image is scaled down with regard to dimensions to be considered.

19. The method according to claim 18, wherein the rest of the image is scaled up again after determining the features and before assigning the classes.

20. The method according to claim 15, wherein the region in the image is selected based on a position of the environment detection arrangement in the device, with respect to a plane on which the device moves.

21. The method according to claim 15, wherein the region in the image is selected based on a current position of the device within an environment.

22. The method according to claim 15, wherein the classified resulting image is used to control the device.

23. The method according to claim 15, wherein the device is a robot, or a robotic mower, or a domestic robot, or a robot vacuum cleaner, or a wiping robot, or a floor cleaning device, or a road cleaning device, or an at least partly automated vehicle, or a drone.

24. A computing system for semantic segmentation of an image that has been captured by an environment detection arragement of an automatedly moving device, the computing system configured to:
obtain the image and select a region in the image;
assign each segment of a plurality of segments including image points of the image, one of a plurality of classes within a scope of the semantic segmentation;
based on a ratio of the selected region to the image, use a higher proportion of a computing power of the computing system for the selected region of the image than for the rest of the image; and
generate and output a classified resulting image.

25. A mobile device, comprising:
an environment detection arrangement configured to capturing an image of an environment; and
a computing system for semantic segmentation of the, the computing system configured to:
obtain the image and select a region in the image;
assign each segment of a plurality of segments including image points of the image, one of a plurality of classes within a scope of the semantic segmentation;
based on a ratio of the selected region to the image, use a higher proportion of a computing power of the computing system for the selected region of the image than for the rest of the image; and
generate and output a classified resulting image.

26. The device according to claim 25, wherein the device is a robot, or a robotic mower, or a domestic robot, or a robot vacuum cleaner, or a wiping robot, or a floor cleaning device, or a road cleaning device, or an at least partly automated vehicle, or a drone.

27. A non-transitory machine-readable storage medium on which is stored a computer program for semantic segmentation of an image that has been captured by an environment detection arragement of an automatedly moving device, using a computing system having computing power, the computer program, when executed by the computing system, causing the computing system to perform the following steps:
obtaining the image and selecting a region in the image;
assigning each segment of a plurality of segments including image points of the image, one of a plurality of classes within a scope of the semantic segmentation;
based on a ratio of the selected region to the image, using a higher proportion of the computing power for the selected region of the image than for the rest of the image; and
generating and outputting a classified resulting image.
